(19) United States
(12) Patent Application Publication
(10) Pub. No.: US 2006/0050373 A1
(43) Pub. Date: Mar. 9, 2006

(54) Probe for an optical near field microscope and method for producing the same

(75) Inventors: Albrecht Brandenburg, Frciburg (DE); Christa Kunzel, Schlicngen (DE); Dietmar Eberhard, Kenzigen (DE)

Correspondence Address: BROOKS KUSHMAN P.C., 1000 TOWN CENTER, TWENTY-SECOND FLOOR, SOUTHFIELD, MI, 48075, US

(73) Assignee: Fraunhofer-Gesellschaft Zur Forderung Der Angewandten Forschung E.V., Munchen (DE)

(21) Appl. No.: 11/193,962

(22) Filed: Jul. 29, 2005

Related U.S. Application Data
(63) Continuation of application No. PCT/EP03/14555, filed on Dec. 18, 2003.

(30) Foreign Application Priority Data
Jan. 31, 2003 (DE) 103 03 961.9

(51) Int. Cl. G02B 21/00

(52) U.S. Cl. 359/368

(57) ABSTRACT

This invention relates to a probe for an optical near field microscope, said probe comprising a probe tip which is formed on a self-supporting carrier and to a method for producing the same. One object of this invention is to provide a probe for an optical near field microscope and a method of producing the same, whereby the probe has a probe tip with a very small aperture diameter and thus can be reproducibly manufactured in a simple, advantageously controllable method. This object is solved with regard to the probe by a generic probe which is characterised in that the probe tip is embodied as a complete structure which is applied to a planar surface of the carrier. The object is solved with regard to a method for the manufacture of a probe for an optical near field microscope according to the invention by a method with the steps: a transparent layer is applied to a substrate, the thickness of the transparent layer corresponding to at least the height of the probe tip; the transparent layer is masked in at least one region of the probe tip; the transparent layer is etched, forming the probe tip.

### CROSS-REFERENCE TO RELATED APPLICATIONS

This application claims priority to and is a continuation of PCT/EP2003/014555, filed Dec. 18, 2003, designating the United States.

### BACKGROUND OF THE INVENTION

1. Field of the Invention

This invention relates to a probe for an optical near field microscope, said probe comprising a probe tip which is formed on a self-supporting carrier and to a method for producing the same.

2. Background Art

Optical near field microscopes are used for the analysis of surfaces. Here, a probe with a very small aperture diameter is brought close to a sample surface and a local electromagnetic field is detected which is denoted as an optical near field. The size of the probe aperture and the distance of this aperture to the sample surface are decisive for the resolving capacity of a near field microscope. In known devices the distance of the aperture to the sample surface can, for example, already be set to very short distances with a shear force mechanism or a piezo-controller. However, it is still very difficult to produce very small aperture sizes reproducibly.

Currently, probes are manufactured for near field microscopes which consist of an optical fibre, which runs to a tip at one end by drawing at high temperatures. At the side the drawn fibres are coated with metal so that a small aperture is produced at one end of the fibre through which light can be emitted from the fibre. These types of aperture have a size of approximately 100 nanometres. Although the optical resolution of a near field microscope which can be thus achieved is higher than that of a conventional microscope, it is not however orders of magnitude better.

In addition the glass fibre tips which are described above cannot be reproduced as desired, so that after a change of the fibre tip the images of the optical near field microscope can vary with regard to resolution and contrast. Changing a tip in a near field microscope is also complicated, because each time the complete fibre probe must be changed. Also, the entry of the fibre light into the fibre must be re-optimised. Furthermore, only a single tip can be manufactured with the fibre drawing method in one work cycle, which renders the probes very expensive.

The publication U.S. Pat. No. 5,354,985 shows a probe tip for an optical near field microscope and an associated method. The probe tip is produced by means of an etching method on a planar, opaque silicon carrier, covered with an SiO₂ and an Si₃N₄ layer and is sheathed in an opaque aluminum layer with only the peak of the tip being exposed.

The Si₃N₄ layer located between the SiO₂ and the aluminum layers forms a waveguide, which transports light entering at the side to the probe tip. Also here, due to the shape of the light guide to the probe tip, substantial light losses are to be expected.

The publication JP 11-281657 describes the probe tip structures and their manufacture. According to an embodiment of this publication a probe tip formed as a complete structure is formed with a tip region on a planar carrier, the said tip region centering on a point. The carrier and the tip are covered with an opaque layer, on which a transparent layer has been applied, which in turn is covered by an opaque layer. The transparent layer sheathed in the opaque layer leads light from a side region of the structure through to the probe tip.

The publication DE 197 13 746 A1 shows a sensor for simultaneous atomic force microscopy and optical near field microscopy. The sensor comprises a fully transparent, unsheathed probe tip, to which a waveguide leads, embedded in two sheath layers, to guide the light to the probe tip. Flat electrodes are provided on the underside and the upper side of a spring beam, formed from the waveguide and the sheath layers.

The publication DE 43 14 301 C1 discloses a scanning device for the examination of surface structures and an associated method. The scanning device comprises sensor tips of photo-structured glass, whereby the glass on the side opposite the tips is provided with a reflective coating. The tips themselves comprise no reflective coating.

The publication DE 195 09 903 A1 describes a method for the manufacture of a probe, for which a silicon nitride layer applied on a silicon substrate is etched isotropically to a completely structured tip via a structured lacquer layer. The tip thus etched can be arranged on a carrier joined in a self-supporting manner to a substrate.

DE 199 26 601 A1 describes a probe and an associated manufacturing method, whereby a probe tip is formed in the shape of a hollow funnel, the inner walls of which are covered with an oxide and which extends through the thickness of a bending beam which is suspended on a substrate.

To manufacture such a probe, first an element is manufactured into which a V-channel with oxide-coated inner walls has been introduced. This element is then fitted to a retaining element which has been produced in a second process and is capable of oscillation. This assembly is then etched from the side of the retaining element so far until a tip region of the coated V-channel protrudes on one side. Due to the large number of steps in the method, the technology is very awkward and expensive and can lead to inadequate reproducibility of the probes due to the joining step used.

U.S. Pat. No. 6,333,497 B2 and U.S. Pat. No. 6,211,532 B1 illustrate funnel-shaped hollow probe tips, which are applied to a carrier by means of hybrid mounting technology. Furthermore, U.S. Pat. No. 5,966,482 describes a probe in which a micromechanically manufactured tip is applied to a diaphragm which extends like strips between two supports.

The hybrid mounting techniques mentioned above prove to be very complicated, particularly for the manufacture of very small probe tips and lead to inadequate reproducibility of the results. Therefore, the disadvantages of the glass fibre tips for near field microscopy described above cannot be countered by the quoted technologies.

### SUMMARY OF THE INVENTION

Therefore, one object of this invention is to provide a probe for an optical near field microscope and a method of producing the same, whereby the probe has a probe tip with a very small aperture diameter, the probe exhibits a good luminous efficiency and it can be reproducibly manufactured in a simple, advantageously controllable method.

This object is solved by a probe for an optical near field microscope, which comprises a probe tip formed as a complete structure with a tip region of a transparent material, which is applied to a planar surface of a self-supporting carrier, whereby a circumferential area of the probe tip and/or a surrounding region of the probe tip is covered with an opaque layer, and which is characterised in that the carrier is transparent in a region opposite the probe tip and light can be focused through the carrier into the probe tip.

The probe according to the invention has the advantage that its probe tip can be formed with a very small probe tip diameter, whereby a very small aperture can be made available. The complete structure of the probe tip can be applied to the carrier in a batch process. This enables the dimensions of the probe tip and also its position relative to the carrier to be reproducibly produced in a simple technological sequence of steps.

Advantageously, at least one circumferential area of the probe tip and/or a surrounding region of the probe tip are covered with a layer that is opaque to light. Thus the effect of scattered light on the sample can be reduced which could produce an erroneous measurement result.

According to a preferred embodiment of the invention, the carrier exhibits a material which is resistant to etching with respect to an etcher of a material of the probe tip. The carrier can be protected with this material during the formation of the probe tip.

According to another, advantageous embodiment of the invention, the carrier is joined in a self-supporting manner to a substrate. Thus it is possible to set the carrier with the probe tip into vibration, whereby a probe can be tracked in a vertical direction during a horizontal scan of a sample surface.

The above object is solved with regard to a method for the manufacture of a probe for an optical near field microscope according to the invention by a method with the steps: a transparent layer is applied to a substrate; a further transparent layer is applied and structured on the transparent layer, forming the probe tip on the transparent layer; a circumferential area of the probe tip and/or a surrounding region of the probe tip is coated with an opaque layer; and a region of the transparent layer opposite the probe tip is etched free by etching the substrate from the side opposite the probe tip.

The method according to the invention can preferably be realized in a simple batch process, i.e. in a continual sequence of steps by using only one substrate. The probe tip can here be manufactured as a complete structure by the application of only one layer. The position of the probe tip is defined exactly with the masking step. In addition, exact and reproducible dimensions of the probe tip can be achieved.

According to a particularly favorable embodiment of the invention, the transparent layer is applied at least to one flat surface region of the substrate. This enables the probe tip to be able to be manufactured on this flat surface region with a high accuracy and a high dimensional reproducibility.

According to a further advantageous embodiment of the invention, an etching stop layer is produced between the transparent layer and the substrate. In this way, the substrate can be protected during the etching of the transparent layer. The etching stop layer is particularly well suited to later forming the carrier or the cantilever of the probe.

It is also preferable that the production of the etching stop layer comprises an application of a silicon nitride layer on the substrate before the transparent layer is applied. Silicon nitride here provides a very good etch stop for the etching of the transparent layer, such as for example a silicon oxide layer.

In a further advantageous embodiment of the invention the transparent layer is applied with a layer thickness of approximately 1 to 30 μm, preferably approximately 2 to 20 μm or optimally 3 to 8 μm. With this method a particularly advantageous tip shape can be realized which is very well suited for the measurement of a sample surface.

In a particularly advantageous process method according to the invention the masking comprises an application of an α-silicon layer onto the transparent layer. The α-silicon layer bonds well to the transparent layer and is a very good masking material for the etching of the transparent layer, so that the probe tip can be produced with a high accuracy.

Preferably, the method is carried out with the thinning down of the substrate at least in the region of the probe tip. Consequently, it is possible in an advantageous manner to form the probe tip on a self-supporting carrier.

According to a particularly advantageous embodiment of this invention the thinning down occurs up to an etching stop layer. In this way, the thickness of a self-supporting carrier can be defined on which the probe tip is located.

Preferably, the etching of the transparent layer exhibits an isotropic etching or a combination of isotropic etching and anisotropic etching. With this method a very advantageous tip shape can be realized in an effective way.

Preferably, the method includes the coating of at least one circumferential area of the probe tip and/or of a surrounding region of the probe tip with at least one opaque material. In this way, it is possible to prevent at least partially scattered light, as well as the light from the probe tip, reaching a sample, whereby a measurement result could be distorted.

In a particularly favorable process method the opaque material is vapour-deposited diagonally onto the probe tip. In this way, the side walls of the probe tip can be coated with the opaque material without the probe tip being covered.

According to a preferred embodiment of this invention, the method comprises the incorporation of at least one opening in the opaque material in a tip region of the probe tip. An aperture in the probe tip can be realized with such an opening.

Favorably, the incorporation of at least one opening occurs with a spark erosion method and/or plasma etching. With these methods very small openings in the probe tip can be realized, by means of which a very high resolution for the optical near field microscopy can be achieved.

The invention is explained in more detail based on the embodiments and associated drawings. These show:

### BRIEF DESCRIPTION OF THE DRAWINGS

FIG. 1 a schematic perspective view of an embodiment of a probe for an optical near field microscope;

FIG. 2 to FIG. 14 an embodiment of a method for the manufacture of a probe, for example the probe according to FIG. 1 in schematic representation;

FIG. 15 a schematic plan view onto the probe tip side of a probe with a carrier in the form of a bending beam; and

FIG. 16 a schematic plan view onto the probe tip side of a probe with a carrier in the form of an “A”.

### DETAILED DESCRIPTION OF THE PREFERRED EMBODIMENTS

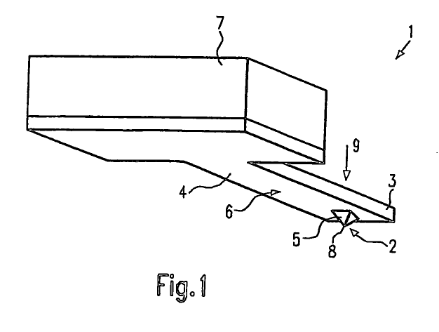

FIG. 1 shows a schematic perspective view of a probe 1 for an optical near field microscope according to one embodiment. The probe 1 comprises a probe tip 2, which is formed on a flat longitudinal surface 4 of a planar self-supporting carrier 3. The illustrated probe tip 2 has a shape similar to a pyramid with approximately triangular circumferential areas 5 and a tip region 8 centering on a point, whereby the tip region 8 points in a direction opposite to the carrier 3.

In other embodiments of the invention the probe tip can exhibit the shape of a cone.

The probe tip consists of a transparent material, such as for example silicon oxide. The carrier 3 consists for example of silicon nitride. The carrier 3 can in other embodiments of the invention also be formed from tantalum oxide, titanium oxide, silicon oxinitride or doped silicon oxide, such as for example phosphor silicate glass.

The circumferential areas 5 of the probe tip 2 and a region 6 of the longitudinal surface 4 of the carrier 3, the said region 6 surrounding the probe tip 2, are covered with an opaque layer 15 (not illustrated in FIG. 1), such as for example aluminum.

The carrier 3 is joined self-supporting on one side to a substrate 7.

The tip region 8 of the probe tip 2 is open, that is, it is not covered by the opaque layer 15. Thus, the probe tip 2 exhibits an aperture in its tip region 8. This enables light, for example by means of a laser beam 9 to be focused through the transparent carrier layer 3 into the probe tip 2 onto the aperture in the tip region 8 of the probe tip 2. The light can then pass through the probe tip 2 to a sample to be examined (not illustrated).

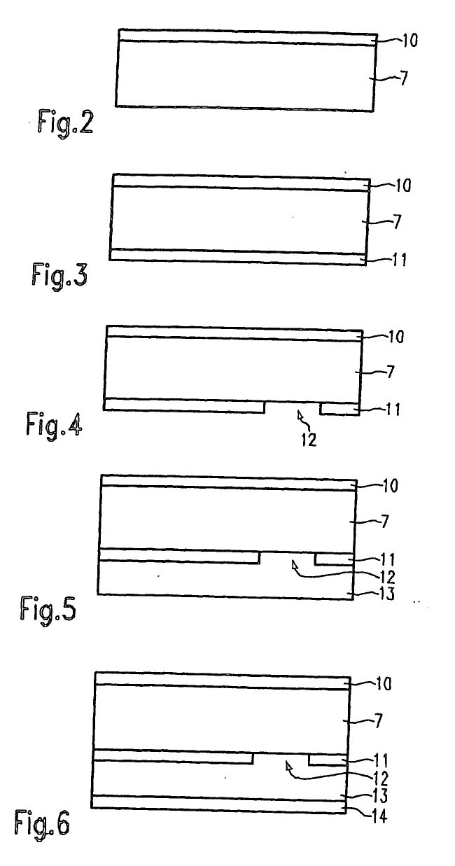

FIG. 2 to FIG. 14 show a sequence of steps of a method for the manufacture of a probe according to the invention, for example the probe from FIG. 1, according to an embodiment of this invention.

FIG. 2 shows in cross-section a substrate 7, which for example consists of silicon. Instead of silicon however, any other substrate material can be used, such as for example a transparent substrate, for example in glass. In a first step, a protective layer 10 was applied to the substrate 7, which, for example, consists of silicon nitride. The protective layer 10 is preferably deposited with a CVD method.

FIG. 3 shows the structure from FIG. 2, whereby an etching stop layer 11 has been applied in a second step to the side of the substrate 7 opposite the protective layer 10. The etching stop layer 11 consists for example of silicon nitride. The etching stop layer 11 is preferably deposited with a thin-film deposition process, such as a CVD method and can be applied to the substrate 7 in one process with the protective layer 10.

The etching stop layer 11 exhibits a transparent material, which preferably has a high refractive index and a high resistance to aggressive environments. The etching stop layer 11 preferably forms the later carrier or cantilever 3.

Since the etching stop layer 11, later as the carrier 3, can be subjected to high mechanical stresses, the etching stop layer 11 must be deposited with low stresses. This then enables the etching stop layer 11 to remain straight after the substrate has been etched away. This can be achieved by special deposition conditions during the deposition of silicon nitride, but also through the use of other materials such as for example silicon oxinitride with a specially adjusted oxygen/nitrogen ratio.

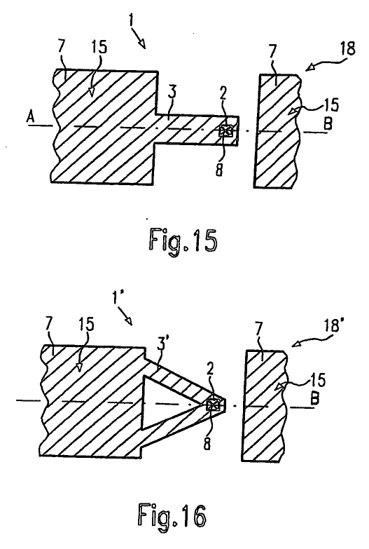

FIG. 4 shows the structure from FIG. 3, whereby an opening region 12 has been produced in a third step in the etching stop layer 11, for example by masking the etching stop layer 11, followed by etching of the etching stop layer 11 in the opening region 12. The etching free of the opening region 12 in the etching stop layer 11 can occur by means of dry etching, for example, of a Si3N4 layer 11. The structuring of the etching stop layer 11 in a fourth step in the method provides a definition of the structure of the self-supporting carrier or cantilever 3. Various geometrical shapes of the carrier 3 can be realized with the structuring. For example, the carrier 3 can, as illustrated in FIG. 15, be configured in the form of a bending beam or, as shown in FIG. 16, it can have the shape of an “A”.

FIG. 5 shows the structure from FIG. 4, whereby a transparent layer 13 has been applied in a fourth step to the structured etching stop layer 11 with the opening region 12. The transparent layer 13 consists for example of silicon oxide. In the illustrated embodiment, the thickness of the transparent layer 13 is approximately 5 μm. In other embodiments of the invention the layer thickness of the transparent layer 13 can be 1 to 13 μm or preferably 2 to 20 μm or optimally approximately 3 to 8 μm. Preferably, the transparent layer is deposited with a CVD method.

FIG. 6 shows the structure from FIG. 5, in which in a fifth step, a masking layer 14, for example in α-silicon, has been applied to the transparent layer 13. Due to the relatively large thickness of the transparent layer 13, the masking layer 14 is of a highly etch-resistant material.

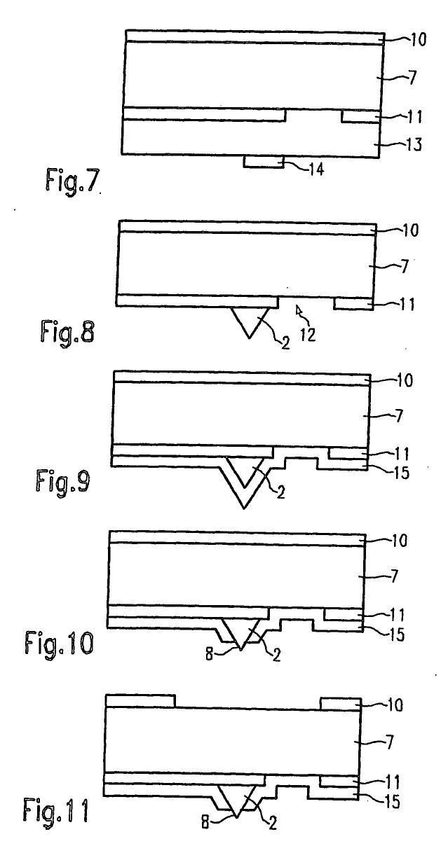

FIG. 7 shows the structure from FIG. 6, whereby the masking layer 14 has been structured. The structuring can occur using photolithography and a following etching step. Once the masking layer 14 has been structured, the masking layer 14 only remains in a region in which the probe tip 2 is to be produced.

FIG. 8 shows the structure from FIG. 7 after a seventh step in the method in which the transparent layer 13 has been etched. The etching can be carried out by isotropic etching or by a combination of anisotropic and isotropic etching. For the isotropic etching step a wet chemical etching can be used. In this case a transparent layer of, for example, silicon oxide can be etched, e.g. with a solution containing HF. The anisotropic etching can take place with a dry etching step. The etching takes place until the probe tip 2 has formed underneath the masking layer 14, whereby the masking layer 14 dissolves. The etching stops further at the etching stop layer 11 and attacks the opening region 12 in the etching stop layer 11 only slightly or not at all.

The wet chemical etching of the transparent layer 13 must be optimised with regard to the shape of the probe tip. Extremely small tip radii arise in the result in a tip region 8 of the probe tip 2, whereby the tip radii are smaller than 100 nanometres and are preferably in the range of approximately 10 to 30 nanometres. The etching can also be controlled by a doping profile in the masking layer, by means of which the etching rates of the material of the transparent layer can be locally influenced. In addition it is possible to precede a wet chemical isotropic etching of the transparent layer 13 with a lateral prestructuring with a dry etching process.

FIG. 9 illustrates the structure from FIG. 8, whereby an opaque layer 15 has been applied in an eighth step to the surface with the probe tip 2. The opaque layer 15 preferably consists of a metal, such as for example aluminum.

For example, an aluminum layer of approximately 50 run thickness can be vapour-deposited or sputtered. Normally, the coating with the opaque material 15 does not just occur at the probe tip 2. According to the illustrated embodiment, the complete underside of the structure is coated so that when using the finished probe in an optical near field microscope, scattered light on the sample from regions of the circumferential areas 5 of the probe tip 2 or from a surrounding region 6 of the probe tip 2 can be suppressed.

FIG. 10 illustrates the structure from FIG. 9 in which the opaque layer 15 has been opened in the tip region 8 of the probe tip 2 in a ninth step. A spark erosion method or a plasma etching step can be used for this.

The spark erosion or the plasma etching method preferentially attack the tip region 8 of the probe tip 2 and there remove the opaque material 15.

In a further embodiment, not shown here, the coating can take place with the opaque material 15 also already structured in that a coating occurs diagonally, for example in a vaporization step from the side.

FIG. 11 illustrates the structure from FIG. 10, whereby in a tenth step the protective layer 10 has been structured on the side of the substrate 7 opposite the probe tip 2. The structuring can take place using photolithography followed by etching of the protective layer 10. After the structuring of the protective layer 10, a region of the protective layer 10 is removed which is located approximately opposite the probe tip 2 in a region of the etching stop layer 11, which later can form the carrier 3. A dry etching method is for example used for removing the protective layer material 10.

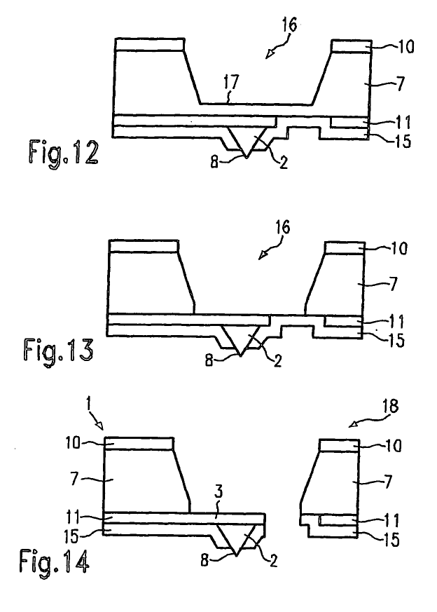

FIG. 12 shows the structure from FIG. 11 after an eleventh step in the method in which the substrate 7 has been etched, for example with a KOH solution, from the side opposite the probe tip 2 with the remaining protective layer 10 as masking layer. During etching, a pit 16 is created, the bottom 17 of which is spaced to the etching stop layer.

FIG. 13 shows the structure from FIG. 12 in which in a twelfth step in the method the substrate material 7 at the bottom of the pit 16 has been anisotropically etched. The pit 16 now extends up to the etching stop layer 11 or to the opaque layer 15 in the opening region 12 of the etching stop layer 11.

The etching free of the self-supporting carrier or cantilever 3 from the side opposite the probe tip is very critical. With a wet chemical etching an undesired etching of the probe tip on the other side of the wafer can occur, for example. With a combined etching, which initially occurs as wet chemical and then dry, it is possible to carefully approach the material of the etching stop layer 11 below the probe tip 2 without attacking the probe tip 2.

FIG. 14 shows the structure from FIG. 13 after a thirteenth step in the method in which the probe 1 has been separated from the remaining material 18. The illustration in FIG. 14 corresponds approximately to the cross-section along the line A-B in FIG. 15. The remaining material 18 shown in FIG. 14 can exhibit a probe adjacent to the probe 1 with almost the same properties as the probe 1.

FIG. 15 is a schematic plan view onto the probe-tip side of the probe 1 in FIG. 14 and onto the underside of the remaining material 18 in FIG. 14. As can be seen in FIG. 15, the carrier 3 of the probe 1 has the shape of a bending beam on the one end of which the probe tip 2 is formed. The side of the probe tip, which corresponds to the underside of the structure in FIG. 14, is, similar to the underside of the remaining material 18, extensively covered with the opaque layer 15, whereby only the tip region 8 of the probe tip 2 is exposed.

FIG. 16 shows a schematic plan view onto the side of the probe tip of another probe 1′ and a remaining material 18′. The probe 1′ exhibits a carrier 3′, which has approximately the shape of an “A”. The probe tip 2 is formed on the upper tip of the “A”-shaped carrier 3′. The probe-tip side of the probe 1′ and also the underside of the remaining material 18′ are covered with the opaque layer 15, whereby only the tip region 8 of the probe tip 2 is not covered. The “A”-shaped form of the carrier 3′ has the advantage that torsion vibrations of the carrier or the cantilever 3′ can be well suppressed.

Separation can take place by means of a conventional sawing step. Thus, a probe 1 is created, which as shown in FIG. 1, exhibits a carrier 3, which is formed from the etching stop layer material 11, whereby the carrier 3 lies on the substrate 7 and at one front end on a longitudinal surface of the carrier 3 the probe tip 2 is formed with an exposed tip region 8 and a sheath of the opaque material 15.

When sawing, the probe tip 2 and the carrier 3 require special mechanical protection.

With the aid of the technology sequence described above, the probe tip 2 can be reproducibly manufactured with the same dimensions and at the same position. The manufacture of the probe tip occurs in a batch process which means that all the process steps can occur consecutively using one substrate through to the production of the finished probe structure, whereby all individual structures of the substrate can be processed in parallel. In this way, high effectiveness of the process with simultaneously high reproducibility, in particular of the probe tip dimensions, is achieved.

With this method a probe tip is realized which has a very small tip radius of a magnitude of less than 100 nanometres, preferably from approximately 10 to 30 nanometres, whereby an exposed tip region 8 can be produced which can provide a very small aperture with a radius of approximately 20 to 50 nanometres.

The manufactured probe is easy to handle, because it is located on a strong substrate. Thus, the probe can be relatively easily changed in an optical near field microscope. Due to the specific suspension of the probe tip at the self-supporting carrier 3, the probe can vibrate, whereby with an optical near field microscope a closed-loop control of the Z position of the probe can be easily provided.

What is claimed is:

1. Probe for an optical near field microscope, which comprises a probe tip, formed as a complete structure, with a tip region of a transparent material, which is applied to a planar surface of a self-supporting carrier, wherein a circumferential area of the probe tip and/or a surrounding region of the probe tip is covered with an opaque layer, characterised in that the carrier is transparent in a region opposite the probe tip and light can be focused through the carrier into the probe tip.

2. Probe according to claim 1, characterised in that the carrier comprises a material, which is etch-resistant with respect to an etcher of a material of the probe tip.

3. Probe according to claim 1, characterised in that the carrier is joined to a substrate in a self-supporting manner.

4. Method for the manufacture of a probe with a probe tip for an optical near field microscope, in particular a probe according to at least one of the previous claim 1, with the following steps:
a transparent layer is applied to a substrate;
a further transparent layer is applied and structured on the transparent layer, forming the probe tip on the transparent layer;
a circumferential area of the probe tip and/or a surrounding region of the probe tip is coated with an opaque layer; and
a region of the transparent layer opposite the probe tip is etched free by etching the substrate from the side opposite the probe tip.

5. Method according to claim 4, characterised in that the further transparent layer is applied to at least one flat surface region of the substrate.

6. Method according to claim 4, characterised in that the transparent layer forms an etching stop layer.

7. Method according to claim 4, characterised in that the transparent layer is a silicon nitride layer.

8. Method according to claim 4, characterised in that the further transparent layer is applied with a layer thickness of approximately 1 to 30 μm, preferably approximately 2 to 20 μm or optimally from approximately 3 to 8 μm.

9. Method according to claim 4, characterised in that the structuring of the further transparent layer includes masking with the application of an α-silicon layer onto the further transparent layer.

10. Method according to claim 4, characterised in that the substrate is initially thinned down at least in the region of the probe tip and thereafter the substrate is removed at least in this region up to the exposure of the transparent layer.

11. Method according to claim 4, characterised in that the structuring of the further transparent layer comprises an isotropic etching or a combination of isotropic etching and anisotropic etching.

12. Method according to claim 4, characterised in that the opaque material is vapour-deposited diagonally onto the probe tip.

13. Method according to claim 4, characterised in that at least one opening in the opaque material is incorporated in a tip region of the probe tip.

14. Method according to claim 13, characterised in that the incorporation of at least one opening occurs with a spark erosion method and/or plasma etching.
